(19) United States
(12) Patent Application Publication
(10) Pub. No.: US 2026/0204819 A1
(43) Pub. Date: Jul. 16, 2026

(54) SYSTEMS AND METHODS FOR ENSURING PROPER COUPLING OF CONNECTORS

(71) Applicant: Dell Products L.P., Round Rock, TX (US)

(72) Inventors: Hou-Chun WANG, New Taipei City (TW); Ernesto RAMIREZ, Austin, TX (US); Ming-Chen CHANG, Austin, TX (US); Cheng-Hsien WANG, New Taipei City (TW); Kuan-Hung CHOU, Taipei (TW)

(73) Assignee: Dell Products L.P., Round Rock, TX (US)

(21) Appl. No.: 19/022,603

(22) Filed: Jan. 15, 2025

(51) Int. Cl. H01R 12/72; H01R 12/79; H01R 13/64

(52) U.S. Cl. CPC H01R 12/721; H01R 12/79; H01R 13/64

(57) ABSTRACT

A terminator configured to couple to a connector mounted on a circuit board may include a pair of side edges located on opposite sides of the terminator, each side edge configured to mechanically engage with a respective lateral guiding feature of the connector to constrain lateral motion of the terminator during insertion into the connector and a pair of notches located on the opposite sides of the terminator, edge notch configured to mechanically engage with a respective locking feature of the connector when the terminator is fully inserted into the connector to maintain the terminator in a fixed position relative to the connector.

### TECHNICAL FIELD

The present disclosure relates in general to information handling systems, and more particularly to systems and methods for providing an over-center latch for mechanically and electrically coupling an information handling resource (e.g., implemented on a flexible printed circuit or coupled via a flexible flat cable) to a circuit board (e.g., motherboard).

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems may utilize flexible printed circuits (FPCs) and/or flexible flat cables (FFCs). An FPC, also known as a flex circuit, may comprise a flexible plastic substrate (e.g., polyimide film, transparent conductive polyester film, polyether ether ketone film) with electronic devices mounted thereon. An FFC may comprise any variety of electrical cable that is both flat and flexible, with flat solid conductors. In some instances, the term FFC refers to extremely thin flat cables often found in high-density electronic applications like laptops and mobile phones.

Using existing approaches, assembly of FFC and FPC connectors to corresponding connectors mounted to circuit boards face many challenges. Improper assembly can lead to numerous problems, including poor electrical contact, device failure, electrical shorts, and/or other problems.

### SUMMARY

In accordance with the teachings of the present disclosure, the disadvantages and problems associated with existing approaches to mechanical and electrical coupling between an information handling resource and a circuit board may be reduced or eliminated.

In accordance with embodiments of the present disclosure, an information handling system may include a circuit board and a connector mounted to a surface of the circuit board. The connector may include a body, a recess formed in the body and configured to receive a portion of a terminator, wherein the recess comprises a plurality of electrical contacts each configured to electrically couple to one or more corresponding electrical pins of the terminator, a pair of lateral guiding features located on opposite sides of the body and proximate to an opening of the recess wherein each lateral guiding feature is configured to mechanically engage with a respective side edge of the terminator to constrain lateral motion of the terminator during insertion into the connector, and a pair of locking features formed on a second portion of the body opposite from the first portion and located proximate to the opening of the recess on opposite sides of the second portion. Each locking feature may be configured to mechanically engage with a respective notch formed in the terminator when the terminator is fully inserted into the connector to maintain the terminator in a fixed position relative to the connector and may comprise a sloped portion such that the sloped portions of the locking features and an angled chamfer define an angled channel for insertion and removal of the terminator into and from the connector.

In accordance with these and other embodiments of the present disclosure, a connector configured to mount to a surface of the circuit board may include a body, a recess formed in the body and configured to receive a portion of a terminator, wherein the recess comprises a plurality of electrical contacts each configured to electrically couple to one or more corresponding electrical pins of the terminator, a pair of lateral guiding features located on opposite sides of the body and proximate to an opening of the recess wherein each lateral guiding feature is configured to mechanically engage with a respective side edge of the terminator to constrain lateral motion of the terminator during insertion into the connector, and a pair of locking features formed on a second portion of the body opposite from the first portion and located proximate to the opening of the recess on opposite sides of the second portion. Each locking feature may be configured to mechanically engage with a respective notch formed in the terminator when the terminator is fully inserted into the connector to maintain the terminator in a fixed position relative to the connector and may comprise a sloped portion such that the sloped portions of the locking features and an angled chamfer define an angled channel for insertion and removal of the terminator into and from the connector.

In accordance with these and other embodiments of the present disclosure, a terminator configured to couple to a connector mounted on a circuit board may include a pair of side edges located on opposite sides of the terminator, each side edge configured to mechanically engage with a respective lateral guiding feature of the connector to constrain lateral motion of the terminator during insertion into the connector and a pair of notches located on the opposite sides of the terminator, edge notch configured to mechanically engage with a respective locking feature of the connector when the terminator is fully inserted into the connector to maintain the terminator in a fixed position relative to the connector.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of selected components of an example information handling system, in accordance with embodiments of the present disclosure;

FIG. 2A illustrates a top elevation view of a connector, in accordance with embodiments of the present disclosure;

FIG. 2B illustrates an isometric perspective view of the connector of FIG. 2A, in accordance with embodiments of the present disclosure;

FIG. 2C illustrates a cross-sectional side elevation view of the connector of FIGS. 2A and 2B, in accordance with embodiments of the present disclosure;

FIG. 3 illustrates an isometric perspective view of a terminator configured to mechanically and electrically couple to the connector of FIGS. 2A-2C, in accordance with embodiments of the present disclosure;

FIGS. 4A-4C illustrate cross-sectional side elevation views of various steps for insertion of the terminator of FIG. 3 into the connector of FIGS. 2A-2C, in accordance with embodiments of the present disclosure; and

FIGS. 5A-5C illustrate isometric perspective views of various steps for insertion of the terminator of FIG. 3 into the connector of FIGS. 2A-2C, wherein FIGS. 5A, 5B, and 5C correspond to FIGS. 4A, 4B, and 4C, respectively, in accordance with embodiments of the present disclosure.

### DETAILED DESCRIPTION

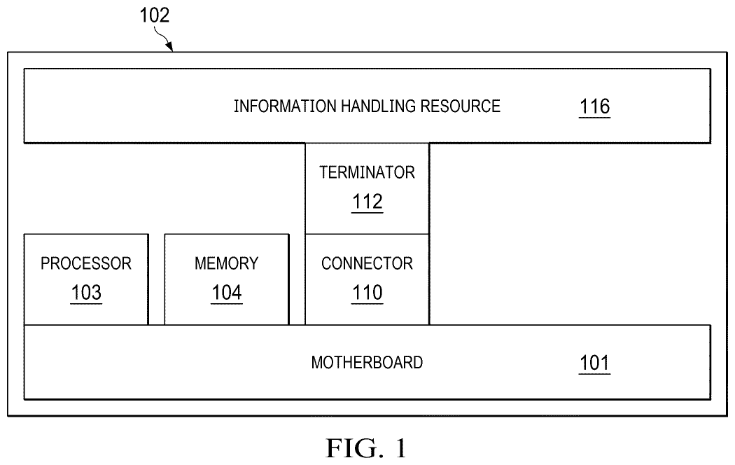

Preferred embodiments and their advantages are best understood by reference to FIGS. 1 through 5C, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”), microcontroller, or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems (BIOSs), buses, memories, I/O devices and/or interfaces, storage resources, network interfaces, motherboards, and/or any other components and/or elements of an information handling system.

For the purposes of this disclosure, circuit boards may broadly refer to printed circuit boards (PCBs), printed wiring boards (PWBs), printed wiring assemblies (PWAs), etched wiring boards, and/or any other board or similar physical structure operable to mechanically support and electrically couple electronic components (e.g., packaged integrated circuits, slot connectors, etc.). A circuit board may comprise a substrate of a plurality of conductive layers separated and supported by layers of insulating material laminated together, with conductive traces disposed on and/or in any of such conductive layers, with vias for coupling conductive traces of different layers together, and with pads for coupling electronic components (e.g., packaged integrated circuits, slot connectors, etc.) to conductive traces of the circuit board.

FIG. 1 illustrates a block diagram of selected components of an example information handling system 102. In some embodiments, information handling system 102 may comprise a server. In other embodiments, information handling system 102 may comprise networking equipment for facilitating communication over a communication network. In yet other embodiments, information handling system 102 may comprise a personal computer, such as a laptop, notebook, or desktop computer.

As shown in FIG. 1, information handling system 102 may include a motherboard 101, a processor 103 coupled to motherboard 101, a memory 104 coupled to motherboard 101, a connector 110 mechanically and electrically coupled to motherboard 101, an information handling resource 116 comprising a terminator 112 wherein information handling resource 116 is electrically coupled to motherboard 101 via connectors 110 and 112. Motherboard 101 may comprise a circuit board configured to provide structural support for one or more information handling resources of information handling system 102 and/or electrically couple one or more of such information handling resources to each other and/or to other electric or electronic components external to information handling system 102.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in a storage resource, memory system 104, and/or another component of information handling system 102.

Memory 104 may be communicatively coupled to processor 103 and may comprise any system, device, or apparatus operable to retain program instructions or data for a period of time (e.g., computer-readable media). Memory 104 may comprise random access memory (RAM), electrically erasable programmable read-only memory (EEPROM), a PCMCIA card, flash memory, magnetic storage, opto-magnetic storage, or any suitable selection and/or array of volatile or non-volatile memory that retains data after power to information handling system 102 is turned off. In particular embodiments, memory 104 may comprise dynamic random access memory (DRAM).

Connector 110 may comprise any system, device, or apparatus fixedly mounted on motherboard 101 and may be constructed to mechanically couple a corresponding information handling resource to motherboard 101 and to electrically couple such riser card 106 to motherboard 101, processor 103, and/or other components of information handling system 102. Connector 110 may comprise a socket including a receptacle slot or other opening configured to removably receive a corresponding mating edge of terminator 112 of information handling resource 116.

Information handling resource 116 may include any component system, device or apparatus of information handling system 102, including without limitation a processor, bus, computer-readable medium, input-output device and/or interface, storage resource, network interface, motherboard, electro-mechanical device (e.g., fan), display, and/or power supply (e.g., voltage regulator). In some embodiments, information handling resource 116 may be implemented in whole or part by an FPC and/or FFC.

As shown in FIG. 1, information handling resource 116 may be electrically coupled to connector 110 via terminator 112, which may in some embodiments be an edge connector. In some embodiments, terminator 112 may comprise a terminator of an FPC or FFC.

In addition to motherboard 101, processor 103, memory 104, connector 110, terminator 112, and information handling resource 116, information handling system 102 may include one or more other information handling resources.

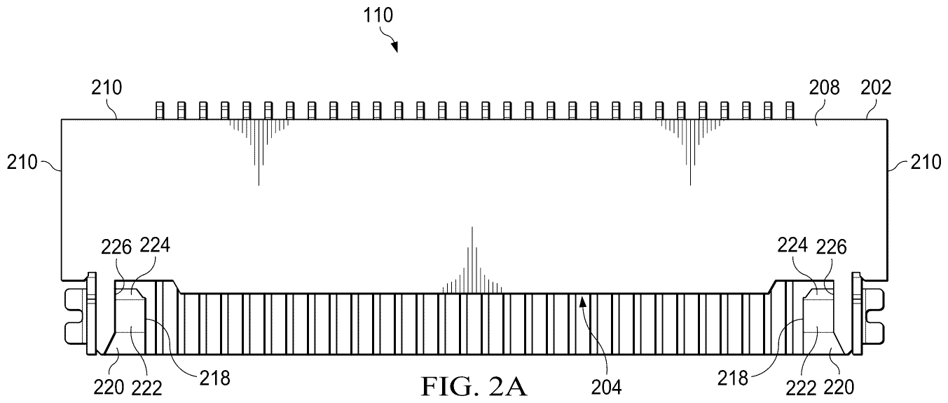

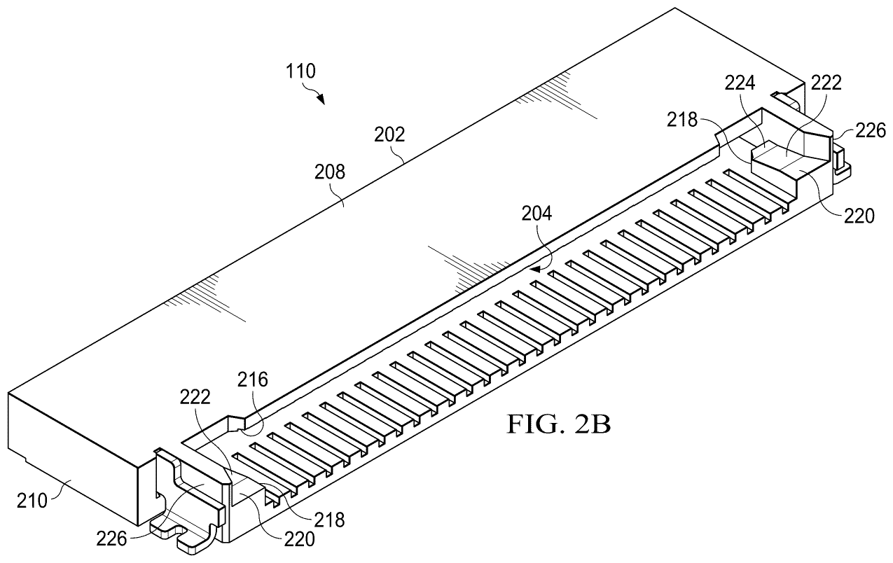

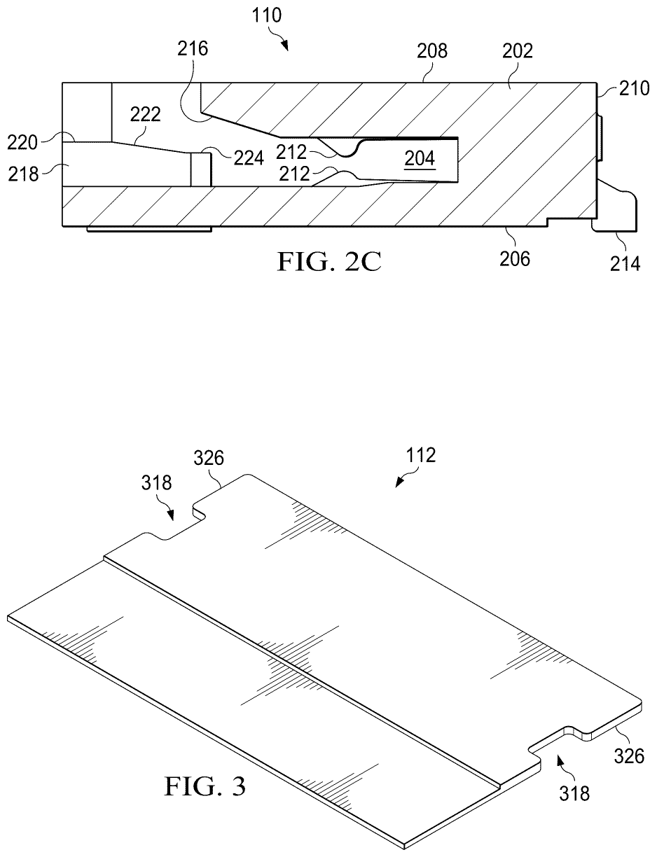

FIG. 2A illustrates a top elevation view of connector 110, in accordance with embodiments of the present disclosure. FIG. 2B illustrates an isometric perspective view of connector 110, in accordance with embodiments of the present disclosure. FIG. 2C illustrates a cross-sectional side elevation view of connector 110, in accordance with embodiments of the present disclosure. FIG. 3 illustrates an isometric perspective view of terminator 112, which may be configured to mechanically and electrically couple to connector 110, in accordance with embodiments of the present disclosure.

As shown in FIGS. 2A-2C, connector 110 may include a body 202 having a recess 204 formed within body 202. Body 202 may include a bottom portion 206, a top portion 208, and a side portion 210 between bottom portion 206 and top portion 208, such that bottom portion 206, top portion 208, and side portion 210 define a volume of recess 204.

A plurality of electrical contacts 212 may be located within recess 204 and may be configured to electrically couple to corresponding pins (not explicitly shown in the figures) of terminator 112. Further, connector 110 may include a plurality of pins 214 protruding from body 202 proximate to where side portion 210 meets bottom portion 206, wherein each of such pins 214 electrically couples to one or more of electrical contacts 212 through body 202. Further, although not explicitly shown in the figures, pins 214 may be electrically and mechanically coupled to motherboard 101 (e.g., via solder or other appropriate mechanism).

Proximate to the opening of recess 204, top portion 208 may have formed therein an angled guiding chamfer 216. Also proximate to the opening of recess 206 and on opposite sides of such opening, locking features 218 may be formed on top of bottom portion 206. As shown in FIGS. 2A-2C, each locking feature may have a width from side portion 210, a length from an edge of bottom portion 206 towards recess 204, and a varying height from bottom portion 206, wherein such height has an overall decrease from the edge of bottom portion 206. For example, such height may decrease from a generally flat (e.g., generally parallel to a surface of motherboard 101 or other circuit board to which connector 110 is mounted) portion 220, to a sloped portion 222 (e.g., generally non-parallel to a surface of motherboard 101 or other circuit board to which connector 110 is mounted), to another generally flat portion 224 smaller in height than flat portion 220.

Also proximate to the opening of recess 206 and on opposite sides of such opening may be formed a pair of lateral guiding features 226.

As shown in FIG. 3, terminator 112 may have formed on opposite sides thereof a pair of notches 318 each configured (e.g., sized and shaped) to mechanically engage with a corresponding locking feature 218 in order to mechanically retain terminator 112 in a fixed position relative to connector 110 when terminator 112 is inserted into recess 204, as described in greater detail below.

As shown in FIG. 3, terminator 112 may have formed on opposite sides thereof a pair of substantially straight edges 326 each configured (e.g., sized and shaped) to mechanically engage with a corresponding lateral guiding feature 226 in order to mechanically guide terminator 112 into connector 110 as terminator 112 is inserted into recess 204, as described in greater detail below.

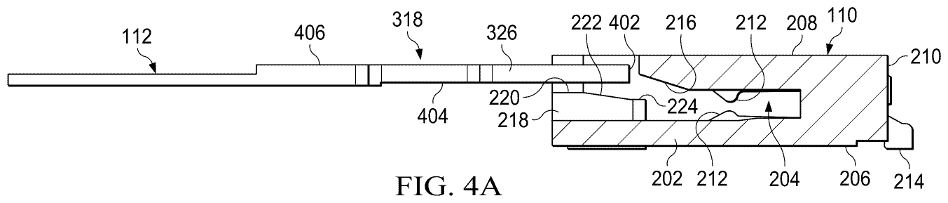

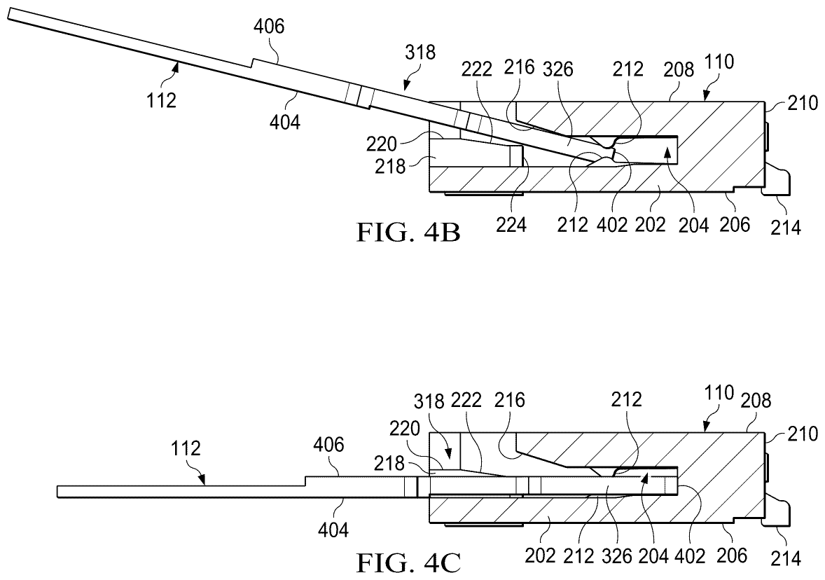

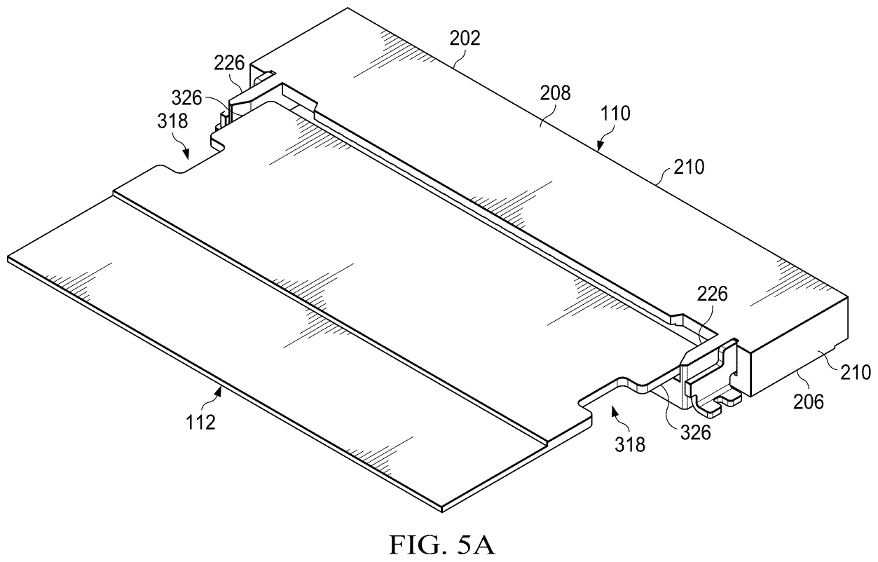

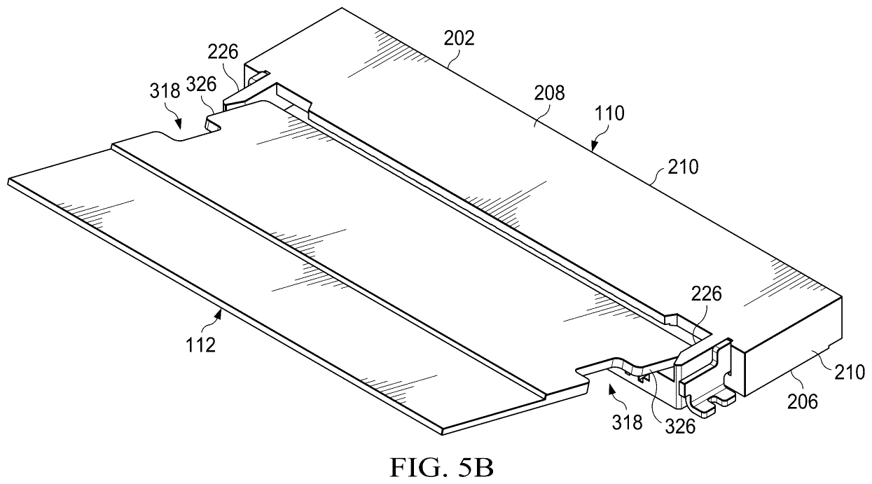

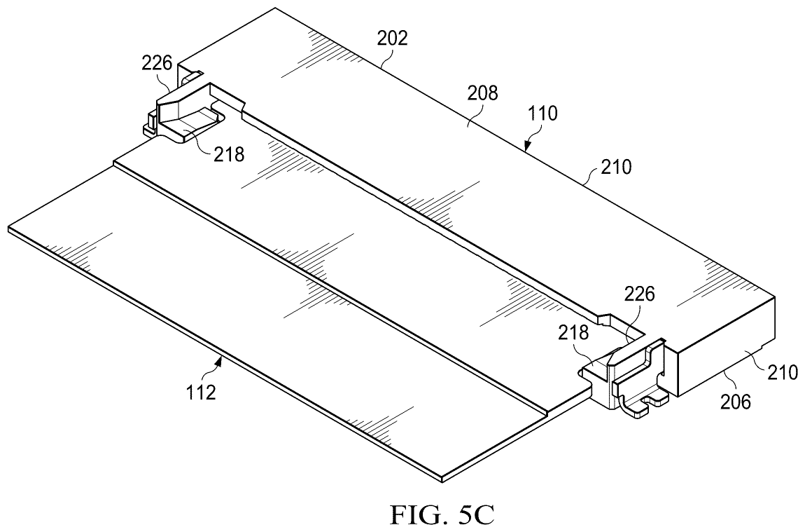

FIGS. 4A-4C illustrate cross-sectional side elevation views of various steps for insertion of terminator 112 into connector 110, in accordance with embodiments of the present disclosure. FIGS. 5A-5C illustrate isometric perspective views of various steps for insertion of terminator 112 into connector 110, wherein FIGS. 5A, 5B, and 5C correspond to FIGS. 4A, 4B, and 4C, respectively, in accordance with embodiments of the present disclosure.

As shown in FIGS. 4A and 5A, insertion of terminator 112 into connector 110 may begin with mechanical translation of terminator 112 towards connector 110, to mechanically engage edges 326 of terminator 112 with lateral guiding features 226 and mechanically engage portions of a bottom surface 404 of terminator 112 with flat portions 220 of locking features 218, to enable sliding of a front edge 402 of terminator 112 to near the opening of recess 204 and ensure proper lateral alignment of terminator 112 relative to connector 110.

As shown in FIGS. 4B and 5B, as front edge 402 of terminator 112 is slid closer to recess 204, front edge 402 and then a top surface 406 of terminator 112 may mechanically engage with angled guiding chamfer 216, and bottom surface 404 of terminator 112 may mechanically engage with sloped portions 222 of locking features 218, to cause terminator 112 to tilt (e.g., such that the planes of bottom surface 404 and top surface 406 are non-parallel to a surface of motherboard 101 or other circuit board upon which connector 110 is mounted). Thus, angled guiding chamfer 216 and sloped portions 222 of locking features 218 may define an angled channel for further insertion of terminator 112 into recess 204 of connector 110.

As shown in FIGS. 4C and 5C, once terminator 112 has been adequately inserted into recess 204 of connector 110 such that notches 318 are above locking features 218, a force may be applied to top surface 406 of terminator 112 to cause notches 318 to mechanically engage with locking features 218, to maintain terminator 112 in a fixed position relative to connector 110. Accordingly, terminator 112 may only be removed from connector 110 by applying an upward force to bottom surface 404 of terminator 112 to disengage notches 318 from locking features 218, and extract terminator 112 through the angled channel.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described above, the principles of the present disclosure may be implemented using any number of techniques, whether currently known or not. The present disclosure should in no way be limited to the exemplary implementations and techniques illustrated in the figures and described above.

Unless otherwise specifically noted, articles depicted in the figures are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

What is claimed is:

1. An information handling system comprising:
a circuit board; and
a connector mounted to a surface of the circuit board, the connector comprising:
a body;
a recess formed in the body and configured to receive a portion of a terminator, wherein the recess comprises a plurality of electrical contacts each configured to electrically couple to one or more corresponding electrical pins of the terminator;
a pair of lateral guiding features located on opposite sides of the body and proximate to an opening of the recess wherein each lateral guiding feature is configured to mechanically engage with a respective side edge of the terminator to constrain lateral motion of the terminator during insertion into the connector; and
a pair of locking features formed on a second portion of the body opposite from the first portion and located proximate to the opening of the recess on opposite sides of the second portion, wherein each locking feature:
is configured to mechanically engage with a respective notch formed in the terminator when the terminator is fully inserted into the connector to maintain the terminator in a fixed position relative to the connector; and
comprises a sloped portion such that the sloped portions of the locking features and an angled chamfer define an angled channel for insertion and removal of the terminator into and from the connector.

2. The information handling system of claim 1, wherein the circuit board is a motherboard.

3. The information handling system of claim 1, wherein the connector is a receptacle connector.

4. The information handling system of claim 1, wherein the terminator terminates a flexible printed circuit.

5. The information handling system of claim 1, wherein the terminator terminates a flexible flat cable.

6. A connector configured to mount to a surface of the circuit board, the connector comprising:
a body;
a recess formed in the body and configured to receive a portion of a terminator, wherein the recess comprises a plurality of electrical contacts each configured to electrically couple to one or more corresponding electrical pins of the terminator;
a pair of lateral guiding features located on opposite sides of the body and proximate to an opening of the recess wherein each lateral guiding feature is configured to mechanically engage with a respective side edge of the terminator to constrain lateral motion of the terminator during insertion into the connector; and
a pair of locking features formed on a second portion of the body opposite from the first portion and located proximate to the opening of the recess on opposite sides of the second portion, wherein each locking feature:
is configured to mechanically engage with a respective notch formed in the terminator when the terminator is fully inserted into the connector to maintain the terminator in a fixed position relative to the connector; and
comprises a sloped portion such that the sloped portions of the locking features and an angled chamfer define an angled channel for insertion and removal of the terminator into and from the connector.

7. The connector of claim 6, wherein the circuit board is a motherboard.

8. The connector of claim 6, wherein the connector is a receptacle connector.

9. The connector of claim 6, wherein the terminator terminates a flexible printed circuit.

10. The connector of claim 6, wherein the terminator terminates a flexible flat cable.

11. A terminator configured to couple to a connector mounted on a circuit board, the terminator comprising:
a pair of side edges located on opposite sides of the terminator, each side edge configured to mechanically engage with a respective lateral guiding feature of the connector to constrain lateral motion of the terminator during insertion into the connector; and
a pair of notches located on the opposite sides of the terminator, edge notch configured to mechanically engage with a respective locking feature of the connector when the terminator is fully inserted into the connector to maintain the terminator in a fixed position relative to the connector.

12. The terminator of claim 11, wherein the circuit board is a motherboard.

13. The terminator of claim 11, wherein the connector is a receptacle connector.

14. The terminator of claim 11, wherein the terminator terminates a flexible printed circuit.

15. The terminator of claim 11, wherein the terminator terminates a flexible flat cable.
